(19) United States
(12) Patent Application Publication
(10) Pub. No.: US 2025/0222483 A1
(43) Pub. Date: Jul. 10, 2025

(54) ASSEMBLIES FOR SERVICING AN INTERIOR OF A FLUID CONTROL VALVE WHILE THE FLUID CONTROL VALVE IS OPERATIONAL

(71) Applicant: FISHER CONTROLS INTERNATIONAL LLC, Marshalltown, IA (US)

(72) Inventors: Justin P. Goodwin, Marshalltown, IA (US); Cory J. Hagen, Johnston, IA (US); Zachary Rochau, Marshalltown, IA (US)

(21) Appl. No.: 18/404,539

(22) Filed: Jan. 4, 2024

(51) Int. Cl. B05B 15/60

(52) U.S. Cl. CPC B05B 15/60

(57) ABSTRACT

A nozzle assembly for servicing an interior of a valve while the valve is operational. The assembly includes a main body adapted to engage a top side of a bonnet of the valve. The assembly includes a spray nozzle that is removably coupleable to the main body and includes a nozzle body removably disposable in a central bore of the main body, and a flow passage extending through a portion of the nozzle body, the flow passage adapted to be coupled to a source of servicing fluid for the fluid control valve. The assembly includes a tip coupled to an end of the nozzle body and in fluid communication with the flow passage, such that when the nozzle body is removably disposed in the central bore of the main body, the tip is positioned to distribute the servicing fluid from the source into an interior of the bonnet.

### FIELD OF THE DISCLOSURE

The present disclosure generally relates to fluid control valves, and, more particularly, to assemblies for servicing an interior of a fluid control valve while the fluid control valve is operational.

### BACKGROUND

Process control systems typically include various components for controlling various process parameters. For example, a fluid process control system may include a plurality of fluid control valves for controlling flow rate, temperature, and/or pressure of a fluid flowing through the system. The end product is dependent on the accuracy of the control of these parameters, which is, in turn, dependent on the geometry and characteristics of the control valves. Fluid control valves are, for example, specifically designed and selected to provide for particular flow capacities and pressure changes. When these characteristics are compromised, the quality of the end product may be affected.

A fluid control valve typically includes components such as a valve body, a valve trim assembly (e.g., a flow control member, a valve stem, a valve seat) disposed in the valve body, a bonnet that is coupled to the valve body and retains the valve stem in position, and various sealing elements (e.g., gaskets, seals) arranged between components of the valve trim assembly and sealing surfaces in the valve body to prevent fluid leakage therebetween. During operation of the fluid control valve, however, particulates may be deposited on the components of the fluid control valve in a manner that affects the proper functionality of the fluid control valve. For example, in some applications a tacky hydrocarbon substance may buildup on the valve trim assembly, thereby interfering with the proper operation of the flow control member.

To ensure that the quality of the end product is not affected, and to ensure that the components of the fluid control valve function properly, the components of the fluid control valve should be frequently cleaned. In some cases, the conventional cleaning process involves shutting down the fluid control valve and completely disassembling the fluid control valve. More specifically, the cleaning process conventionally involves shutting down the fluid control valve, removing the bonnet, removing the valve trim assembly from the valve body, removing the sealing elements, and then soaking or spraying the valve body, the valve trim assembly, the bonnet, or the sealing elements. In some cases, the components of the fluid control valve are cleaned by having an operator of the fluid control valve manually scrub portions or the entirety of the components. However, this cleaning process does not effectively and consistently clean the sealing surfaces of the valve body, which can be difficult to access and view. And even when the cleaning process is effective, the process exposes the operator to potentially dangerous chemicals, materials, or sharp features that may be present in the valve body. Additionally, the process can be time consuming.

### SUMMARY

In accordance with a first exemplary aspect of the present disclosure, a nozzle assembly is provided for servicing an interior of a fluid control valve while the fluid control valve is operational. The nozzle assembly is configured to be coupled to a top side of a bonnet of the fluid control valve. The nozzle assembly includes a main body adapted to engage the top side of the bonnet when the nozzle assembly is coupled to the top side of the bonnet. The main body includes a central bore. The nozzle assembly also includes a spray nozzle removably coupleable to the main body and a flange removably coupleable to the main body to secure the spray nozzle within the main body. The spray nozzle includes a nozzle body removably disposed in the central bore of the main body when the spray nozzle is coupled to the main body. The spray nozzle also includes a flow passage extending through a portion of the nozzle body. The flow passage is adapted to be coupled to a source of servicing fluid for the fluid control valve. The spray nozzle further includes a nozzle tip coupled to an end of the nozzle body and in fluid communication with the flow passage, such that when the main body engages the top side of the bonnet and the nozzle body is removably disposed in the central bore of the main body, the nozzle tip is positioned within an interior of the bonnet, thereby allowing the nozzle tip to distribute the servicing fluid from the source of servicing fluid into the interior of the bonnet.

In accordance with a second exemplary aspect of the present disclosure, an assembly is provided for servicing an interior of a fluid control valve while the fluid control valve is operational. The assembly includes a bonnet adapted to be coupled to a valve body of the fluid control valve. The assembly also includes a nozzle assembly configured to be coupled to a top side of a bonnet of the fluid control valve. The nozzle assembly includes a main body configured to engage the top side of the bonnet when the nozzle assembly is coupled to the top side of the bonnet. The main body includes a central bore. The nozzle assembly also includes a spray nozzle removably coupleable to the main body and a flange removably coupleable to the main body to secure the spray nozzle within the main body. The spray nozzle includes a nozzle body removably disposed in the central bore of the main body when the spray nozzle is coupled to the main body. The spray nozzle also includes a flow passage extending through a portion of the nozzle body. The flow passage is adapted to be coupled to a source of servicing fluid for the fluid control valve. The spray nozzle further includes a nozzle tip coupled to an end of the nozzle body and in fluid communication with the flow passage, such that when the main body engages the top side of the bonnet and the nozzle body is removably disposed in the central bore of the main body, the nozzle tip is positioned within an interior of the bonnet and immediately adjacent an interior of the valve body of the fluid control valve, thereby allowing the nozzle tip to distribute the servicing fluid from the source of servicing fluid into the interior of the body of the fluid control valve.

In accordance with a third exemplary aspect of the present disclosure, a method of servicing an interior of a fluid control valve while the fluid control valve is operational is provided. The fluid control valve includes a body and a bonnet coupled to the body. The method includes obtaining a spray nozzle including a nozzle body, a flow passage extending through a portion of the nozzle body, and a nozzle tip coupled to an end of the nozzle body and in fluid communication with the flow passage. The method includes coupling the spray nozzle to a main body that engages a top side of the bonnet, such that the nozzle body is removably disposed in a central bore of the main body and the nozzle tip is positioned within an interior of the bonnet and immediately adjacent an interior of the valve body of the fluid control valve. The method includes securely retaining the nozzle body in the central bore of the main body by coupling a flange to the main body. The method includes fluidly coupling the flow passage of the spray nozzle to a source of servicing fluid for the fluid control valve. The method further includes distributing, via the nozzle tip, the servicing fluid from the source of servicing fluid into the interior of the bonnet and the interior of the body of the fluid control valve.

In further accordance with any one or more of the foregoing first, second, or third exemplary aspects, a nozzle assembly, an assembly, and/or a method of servicing an interior of a fluid control valve may include any one or more of the following further preferred forms.

In one preferred form, a retaining element is removably disposed between the flange and the spray nozzle, the retaining element configured to retain the nozzle body in the central bore of the main body.

In another preferred form, a sealing element is carried by the nozzle body, the sealing element configured to create a seal between the main body and the spray nozzle.

In another preferred form, the nozzle tip is removably coupled to the end of the nozzle body such that the nozzle tip is removable and replaceable with a second nozzle tip that provides different flow characteristics than the nozzle tip.

In another preferred form, a spray plug is removably disposable in the central bore of the main body when the spray nozzle is decoupled from the main body, the spray plug configured to seal the central bore of the main body.

In another preferred form, the nozzle body has a first portion disposed within the main body and a second portion disposed outside of the main body.

In another preferred form, a controller is communicatively connected to the spray nozzle, the controller configured to cause the nozzle tip to distribute the servicing fluid at a pre-determined time.

In another preferred form, a retaining element is removably disposed between the flange and the spray nozzle, the retaining element configured to retain the nozzle body in the central bore of the main body and to retain the nozzle tip within the interior of the bonnet.

In another preferred form, a spray plug is removably disposable in the central bore of the main body when the spray nozzle is decoupled from the main body, wherein when the spray plug is removably disposed in the central bore of the main body, the flange is removably coupleable to the main body to securely retain the spray plug in the central bore of the main body, such that the spray plug is configured to seal the central bore of the main body.

In another preferred form, the main body is integrally formed with the bonnet.

In another preferred form, the assembly includes a trim assembly adapted to be disposed in the body of the fluid control valve, wherein when the main body engages the top side of the bonnet and the nozzle body is removably disposed in the central bore of the main body, the nozzle tip is positioned immediately adjacent a portion of the trim assembly, such that the nozzle tip distributes the servicing fluid from the source of servicing fluid onto the trim assembly.

In another preferred form, the bonnet includes a central bore adapted to receive a stem for the fluid control valve, wherein the central bore of the bonnet extends along a first axis and wherein the central bore of the main body extends along a second axis that is angled relative to the first axis.

In another preferred form, a gasket is disposed between the main body and the flange when the flange is coupled to the main body.

In another preferred form, the method includes removing the flange from the main body, decoupling the spray nozzle from the main body by removing the nozzle body from the central bore of the main body, obtaining a spray plug, removably disposing the spray plug in the central bore of the main body, and securely retaining the spray plug in the central bore of the main body by re-coupling the flange to the main body.

### BRIEF DESCRIPTION OF THE DRAWINGS

FIG. 1 is a perspective view of one example of an assembly for servicing an interior of a fluid control valve in accordance with the teachings of the present disclosure.

FIG. 2 is a top view of the assembly of FIG. 1.

FIG. 3 is a cross-sectional view taken along line 3-3 in FIG. 2, showing a spray nozzle installed in a bonnet.

FIG. 4 is a close-up view of a portion of FIG. 3.

FIG. 5 is similar to FIG. 4, but with a spray plug installed in place of the spray nozzle.

FIG. 6 is a perspective view of another example of an assembly for servicing an interior of a fluid control valve in accordance with the teachings of the present disclosure.

FIG. 7 is a top view of the assembly of FIG. 6.

FIG. 8 is a cross-sectional view taken along line 8-8 in FIG. 7.

FIG. 9 is a close-up view of a portion of FIG. 8.

FIG. 10 is a cross-sectional view of another example of an assembly for servicing an interior of a fluid control valve in accordance with the teachings of the present disclosure, the assembly including a bonnet and a spray nozzle installed in the bonnet.

FIG. 11 is a close-up view of a portion of FIG. 10.

FIG. 12 is similar to FIG. 10, but shows a spray plug installed in place of the spray nozzle.

### DETAILED DESCRIPTION OF THE DRAWINGS

The present disclosure aims to address the above-discussed problems by providing assemblies for servicing an interior of a fluid control valve with one or more servicing fluids while the fluid control valve is operational. Thus, the assemblies allow the components of the fluid control valve (e.g., the valve trim assembly) within the interior of the fluid control valve to be cleaned without having to shut down the fluid control valve (or, worse yet, without having to shut down and then completely disassemble the fluid control valve). The assemblies also obviate the need for an operator of the fluid control valve to manually scrub portions or the entirety of the components of the fluid control valve.

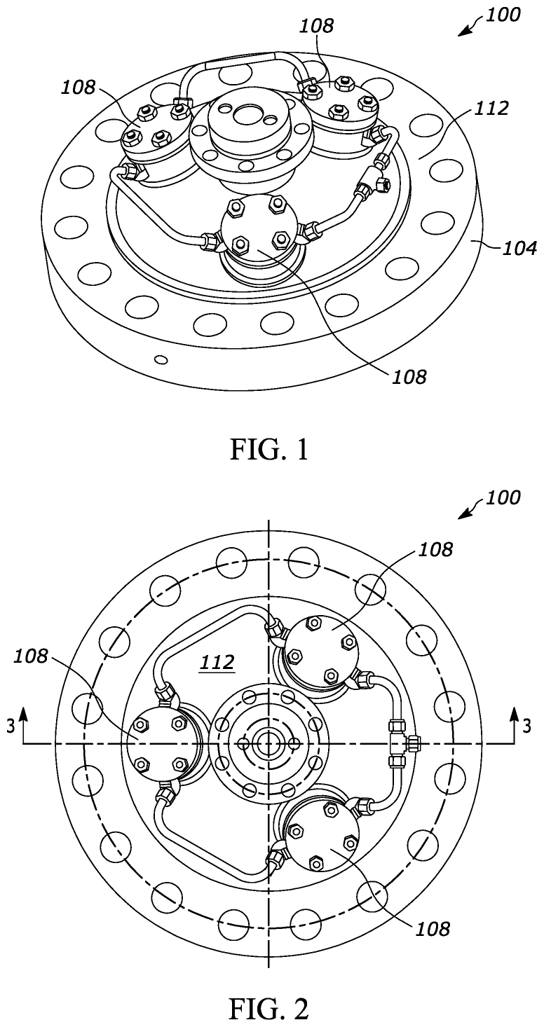

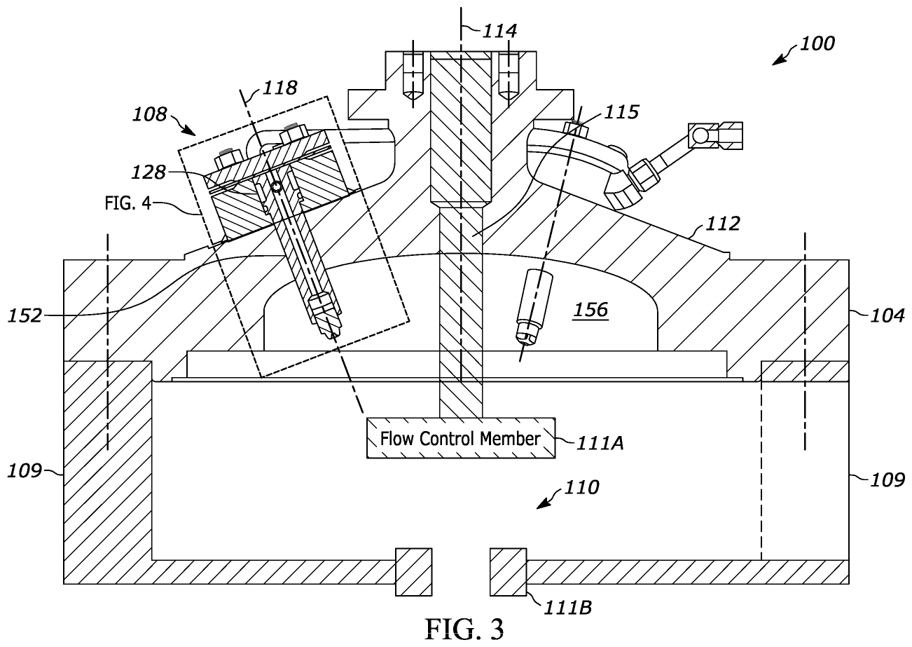

FIGS. 1-5 illustrate one example of an assembly 100 constructed in accordance with the teachings of the present disclosure. Thus, the assembly 100 is configured for servicing an interior of a fluid control valve while the fluid control valve is operational. The assembly 100 generally includes a bonnet 104 and three nozzle assemblies 108 coupled to one another and to the bonnet 104. The bonnet 104, which is generally considered to be part of the fluid control valve, is configured to be coupled to a valve body of the fluid control valve to enclose other components of the fluid control valve in the valve body. For example, in FIG. 3 the bonnet 104 is shown coupled to a valve body 109 to enclose a valve trim assembly 110 (that includes a flow control member 111A, a valve seat 111B, and a valve stem 115) and one or more sealing elements disposed in the valve body 109. The bonnet 104 also has a central bore that extends along a central axis 114 and accommodates the valve stem 115, which extends through the central bore and can in turn control the position of the flow member 111A relative to the valve seat 111B.

As best illustrated in FIGS. 1 and 2, the three nozzle assemblies 108 are coupled to one another and to a source of servicing fluid (not shown) for the fluid control valve via conventional pipes and fittings (e.g., Swagelok pipes and fittings). Each nozzle assembly 108 is coupled to a top side 112 of the bonnet 104, such that the nozzle assemblies 108 are circumferentially arranged about the central axis 114. In this example, each of the nozzle assemblies 108 is welded to the top side 112 of the bonnet 104. In other examples, however, the nozzle assemblies 108 can be removably coupled to the top side 112 of the bonnet 104 or fixedly coupled to the top side 112 of the bonnet 104 in a different manner. In any event, each of the nozzle assemblies 108 is at least partially exposed to the exterior environment when the bonnet 104 is coupled to the valve body of the fluid control valve. In this example, each of the nozzle assemblies 108 is coupled to the top side 112 of the bonnet 104 at an angle relative to the central axis 114 of the bonnet 104. More particularly, each of the nozzle assemblies 108 extends along an axis 118 that is not parallel to the central axis 114 of the bonnet 104 (see FIG. 3). In other examples, however, each of the nozzle assemblies 108 can be coupled to the top side 112 of the bonnet 104 so that the axis 118 is parallel to the central axis 114 of the bonnet 104.

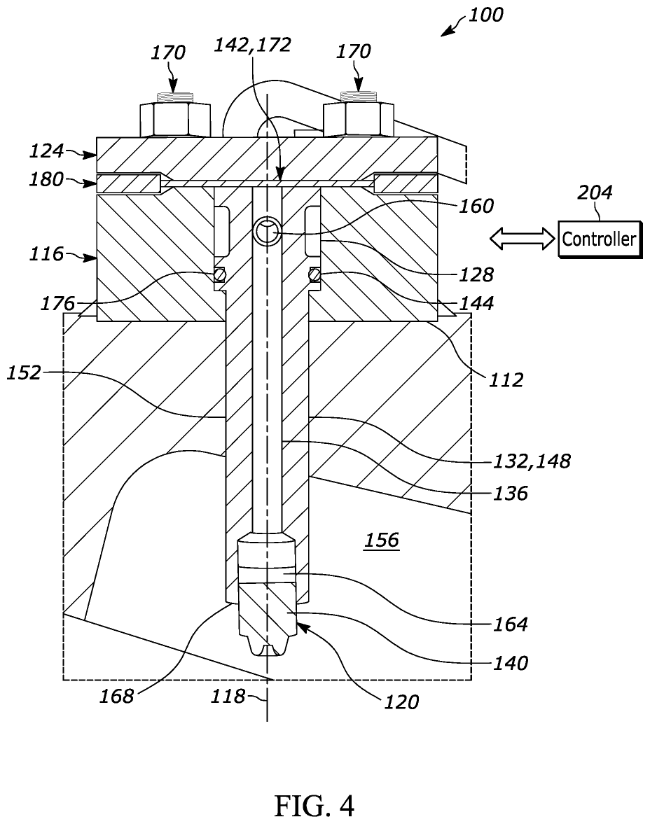

As illustrated in FIGS. 3 and 4, each nozzle assembly 108 generally includes a main body 116, a spray nozzle 120, and a flange 124. When each nozzle assembly 108 is coupled to the top side 112 of the bonnet 104, the main body 116 of that nozzle assembly 108 directly engages (and, at least in this example, is welded to) the top side 112 of the bonnet 104. The spray nozzle 120 is removably coupleable to the main body 116, and the flange 124 is removably coupleable to the main body 116 to secure the spray nozzle 120 within the main body 116.

With reference still to FIGS. 3 and 4, the main body 116 of each spray nozzle assembly 108 has a generally cylindrical shape and includes a central bore 128 that extends along the axis 118. The spray nozzle 120 generally includes a nozzle body 132, a flow passage 136, and a nozzle tip 140 in fluid communication with the flow passage 136. The nozzle body 132 also has a generally cylindrical shape defined by a first portion 144 that has an outer surface having a first diameter at a first end 142 of the nozzle body 132 and a second portion 148 that has an outer surface having a second diameter at a second end 168 of the nozzle body 132 that is less than the first diameter. When the spray nozzle 120 is coupled to the main body 116, the first portion 144 is removably disposed in the central bore 128 of the main body 116, whereas the second portion 148 is partially disposed in the central bore 128, extends through a bore 152 formed in the bonnet 104, and is partially disposed in an interior 156 of the bonnet 104. In other words, the second portion 148 of the nozzle body 132 is at least partially disposed outside of the main body 116.

The flow passage 136 extends through a portion of the nozzle body 132. In this example, the flow passage 136 extends along the axis 118 and through a substantial portion of the nozzle body 132, with the flow passage 136 extending from an inlet 160 positioned in the first portion 144 to an outlet 164 positioned in the second portion 148 immediately adjacent the second end 168. The inlet 160 is configured to be coupled to the source of servicing fluid, while the outlet 164 is positioned within the interior 156 of the bonnet 104.

The nozzle tip 140 is coupled to the second end 168 of the nozzle body 132 such that the nozzle tip 140 is in fluid communication with the outlet 148 of the flow passage 136. In turn, when the main body 116 engages the top side 112 of the bonnet 104 and the nozzle body 132 is disposed in the central bore 128 of the main body 116, the nozzle tip 140 is positioned within the interior 156 of the bonnet 104. Therefore, and when the bonnet 104 is coupled to the valve body of the fluid control valve, the nozzle tip 140 is positioned within an interior of the fluid control valve. Accordingly, the nozzle tip 140 is positioned to distribute the servicing fluid, which flows from the source of servicing fluid and into and through the flow passage 136, into the interior of the bonnet 104 (and into the interior of the fluid control valve).

The nozzle tip 140 is configured to output the servicing fluid into the interior of the fluid control valve with pre-determined flow characteristics. More particularly, the pre-determined flow characteristics are defined by the size, shape, flow capacity, and/or one or more flow paths of the nozzle tip 140. In this example, the nozzle tip 140 is threaded into the second end 168 of the nozzle body 132, such that the nozzle tip 140 can be removed and replaced with a second nozzle tip that outputs the servicing fluid into the interior of the fluid control valve with flow characteristics different from the flow characteristics provided by the nozzle tip 140. In other words, the nozzle tip 140 can be removed and replaced with a second nozzle tip having a different size, shape, flow capacity, and/or one or more flow paths than the nozzle tip 140. In other examples, however, the nozzle tip 140 can be removably coupled to the nozzle body 132 in a different manner (or the nozzle tip 140 can be fixedly coupled to the nozzle body 132).

The flange 124 is a blind flange that has a generally cylindrical shape and a size that match the shape and the size, respectively, of the main body 116. The flange 124 is removably coupleable to the main body 116 via a plurality of fasteners 170. In this example, the flange 124 is removably coupleable to the main body 116 via four fasteners 170. In other examples, however, the flange 124 can be removably coupleable to the main body 116 using more or less fasteners 170. In any event, when the flange 124 is coupled to the main body 116 via the plurality of fasteners 170, the flange 124 helps to retain the other components of the spray nozzle assembly 108 within the spray nozzle assembly 108.

As best illustrated in FIG. 4, each nozzle assembly 108 also includes a retaining element 172 configured to retain the nozzle body 132 in the central bore 128 of the main body 116. To this end, the retaining element 172 is removably disposed between the flange 124 and the spray nozzle 120 when the flange 124 is coupled to the main body 116. Preferably, the retaining element 172 takes the form of a Belleville washer that is disposed between an underside of the flange 124 and the second portion 148 of the nozzle body 132.

As also illustrated in FIG. 4, each nozzle assembly 108 also preferably includes a first sealing element 176 and a second sealing element 180. The first sealing element 176 is configured to create a seal between the main body 116 and the spray nozzle 120. To this end, the first sealing element 176 is, at least in this example, disposed in an aperture formed in an outer surface of the second portion 148 of the nozzle body 132. Thus, when the spray nozzle 120 is coupled to the main body 116, the first sealing element 176 is disposed in the central bore 128 and engages an inner wall of the main body 116, as illustrated in FIG. 4. Meanwhile, the second sealing element 180 is configured to seal off the nozzle assembly 108 from the external environment surrounding the nozzle assembly 108. In this example, the second sealing element 180 takes the form of a sealing gasket (and, more particularly, an o-ring) that is disposed between the underside of the flange 124 and the main body 116. While difficult to observe, the second sealing element 180 has a central aperture that is sized to receive or accommodate the retaining element 172, such that the second sealing element 180 surrounds the retaining element 172.

As discussed above, the assembly 100 is configured to service the interior of the fluid control valve while the fluid control valve is operational. More particularly, when the main body 116 of the one or more of the nozzle assemblies 108 is coupled to the bonnet 104 and the spray nozzle 120 is coupled to the main body 116, the nozzle tip 140 is positioned to distribute the servicing fluid into the interior of the fluid control valve while the fluid control valve is operational. The servicing fluid, which preferably takes the form of a cleaning solvent, a gas, or a liquid, is ejected into the interior of the bonnet 104 and into the fluid control valve and directly onto the internal components of the fluid control valve, e.g., the valve trim assembly 110, the internal surfaces of the valve body, and the sealing elements. The servicing fluid flushes, cleans, or otherwise prepares the internal components of the fluid control valve, all while the fluid control valve is still operational.

At the same time, the spray nozzle 120 can be decoupled from the bonnet 104 after the interior of the fluid control valve has been serviced, all while the fluid control valve remains operational. The spray nozzle 120 can be decoupled from the bonnet 104 by removing the flange 124 from the main body 116, removing the retaining element 172, thereby permitting access to the central bore 128, and then removing the spray nozzle 120 from the central bore 128. The spray nozzle 120 can in turn be replaced with a spray plug 200 that is removably disposable in the central bore 128. With the spray plug 200 disposed in the central bore 128, the retaining element 172 can be positioned on the spray plug 200 and the flange 124 can be recoupled to the main body 116 via the plurality of fasteners 170, thereby securely retaining the spray plug 200 within the central bore 128.

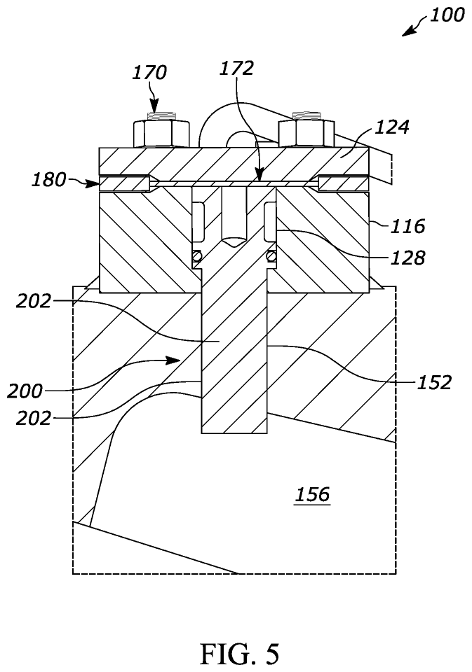

As illustrated in FIG. 5, the spray plug 200 has a plug body 202 that is substantially similar to the nozzle body 132. However, unlike the spray nozzle 120, the spray plug 200 does not include a flow passage (e.g., the flow passage 136) and does not include a nozzle tip (e.g., the nozzle tip 140). Thus, when the plug body 202 is disposed in the central bore 128, the spray plug 200 severs the fluid communication between the interior of the bonnet 104 and the central bore 128 of the main body 116. Accordingly, the spray plug 200 seals the central bore 128 from the interior 156 of the bonnet 104 (and the interior of the fluid control valve) and seals the external environment from the interior 156 of the bonnet 104 (and the interior of the fluid control valve), thereby maintaining the pressure within the interior 156 of the bonnet 104 (and the interior of the fluid control valve).

It will be appreciated that the spray plug 200 can be removed and replaced with the spray nozzle 120 (or a different spray nozzle) in a similar manner when it is necessary to service the fluid control valve while the fluid control valve is in operation. Optionally, the assembly 100 can be communicatively connected (via a wired connection and/or a wireless connection) to a controller (e.g., controller 204) that can monitor and control the spray nozzle 120. For example, when the spray nozzle 120 is installed in the bonnet 104, the controller can cause the spray nozzle 120 to distribute the servicing fluid at a pre-determined time or at pre-determined intervals as a preventive measure to ensure that the fluid control valve continues to operate as intended. Alternatively or additionally, the controller can cause the spray nozzle 120 to distribute the servicing fluid upon determining that maintenance is needed in the fluid control valve (e.g., because the controller has determined that a tacky hydrocarbon substance has built up on the valve trim assembly 110, thereby affecting the proper operation of the flow control member).

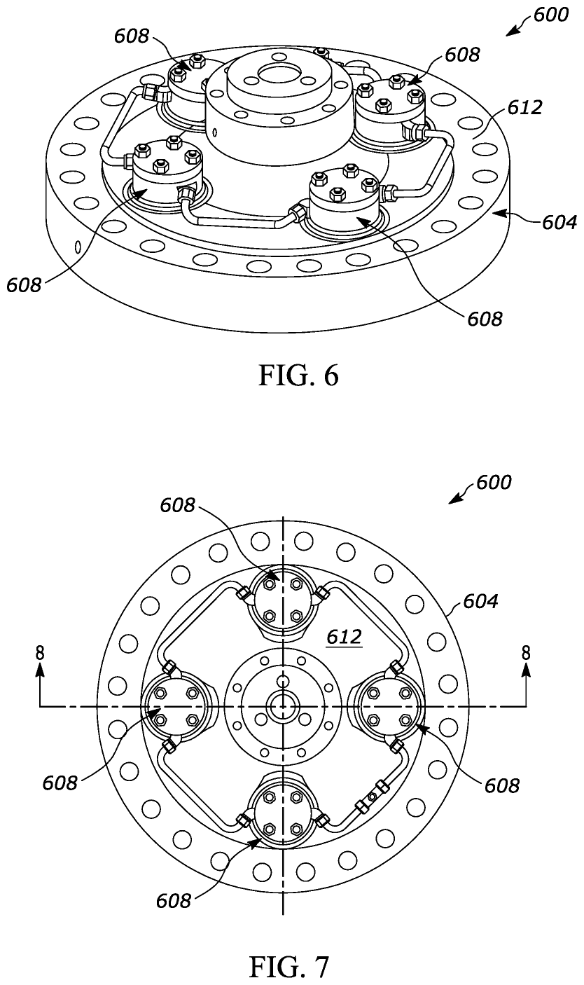

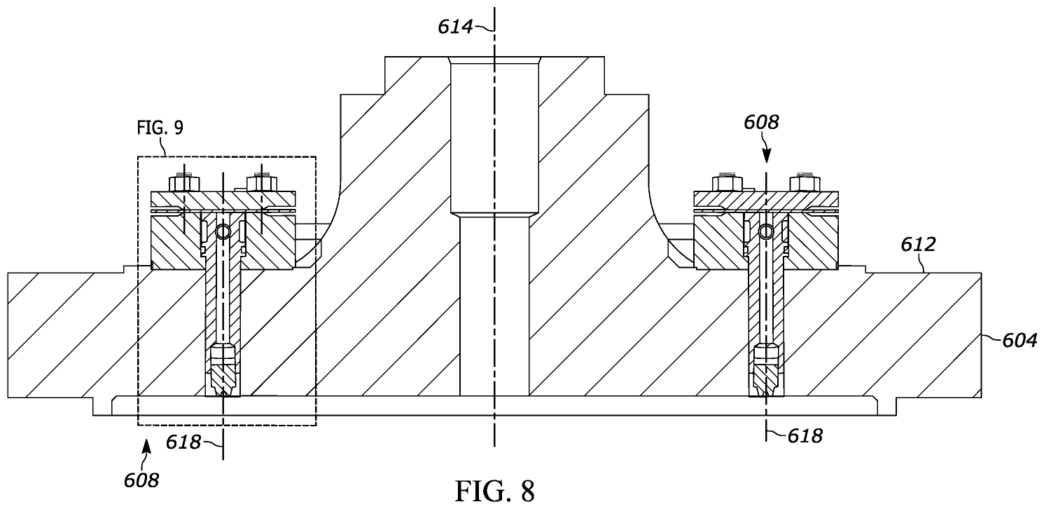

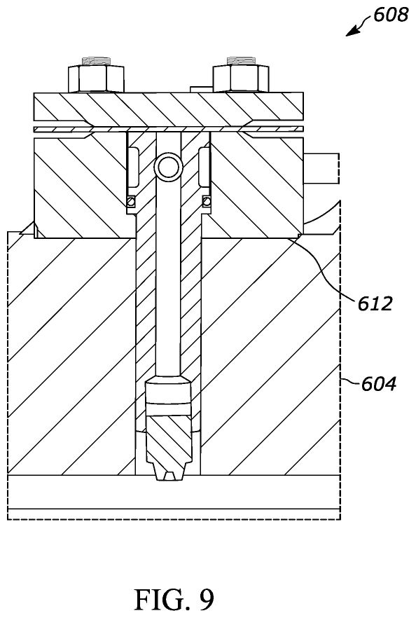

FIGS. 6-9 illustrate another example of an assembly 600 constructed in accordance with the teachings of the present disclosure. Thus, the assembly 600 is likewise configured to service an interior of a fluid control valve while the fluid control valve is operational. The assembly 600 is structurally and functionally similar to the assembly 100 but is different in several ways. First, while the assembly 600 includes a bonnet 604 that is identical to the bonnet 104, the assembly 600 includes four nozzle assemblies 608 coupled to one another and to the bonnet 604. Second, while each of the nozzle assemblies 608 is coupled to a top side 612 of the bonnet 604 in an identical manner as the nozzle assemblies 608 are coupled to the top side 112 of the bonnet 104, the nozzle assemblies 608 are oriented differently relative to a central axis 614 of the bonnet 604. More particularly, unlike the nozzle assemblies 108, which extend along the axis 118 that is not parallel to the central axis 114 of the bonnet 104, each of the nozzle assemblies 608 extends along an axis 618 that is substantially parallel, if not completely parallel, to the central axis 614 of the bonnet 604. However, it will be appreciated from FIGS. 6-8 that each of the nozzle assemblies 608 is otherwise structurally and functionally identical to the nozzle assemblies 108 described above. For example, each of the nozzle assemblies 608 has a spray nozzle that is installable in the bonnet 604 to service an interior of the bonnet 604 (and the fluid control valve) while the fluid control valve is operational, but can be removed and replaced with a spray plug (like the spray plug 200) when desired. Other details about the nozzle assemblies 608 will be omitted for brevity.

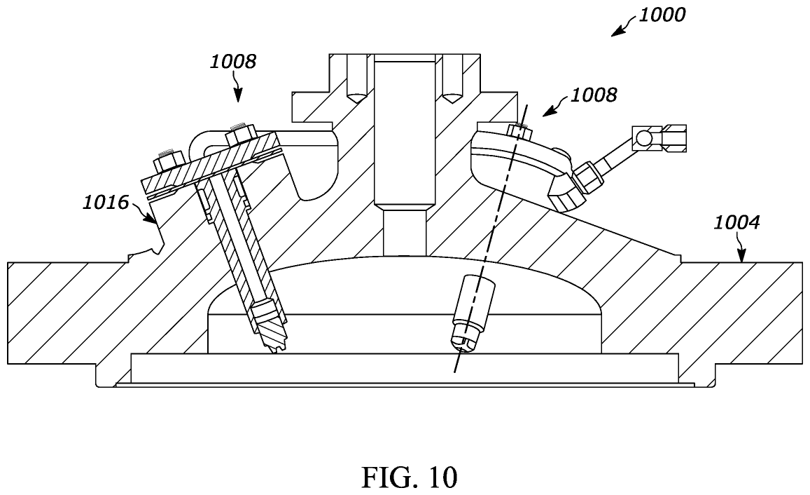

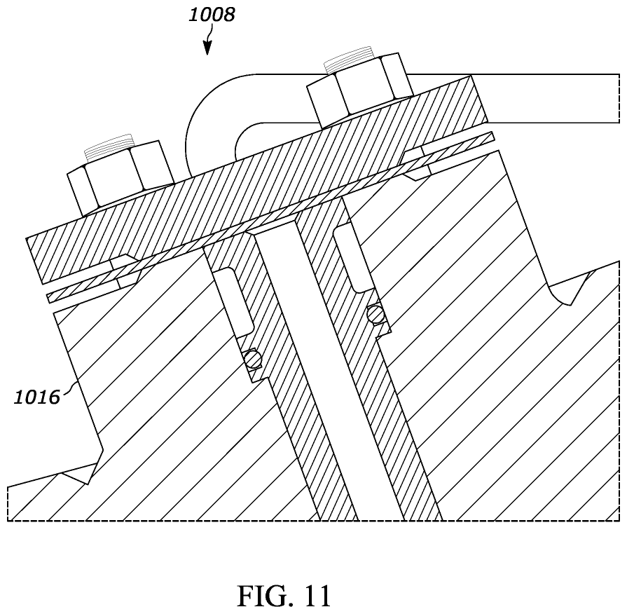

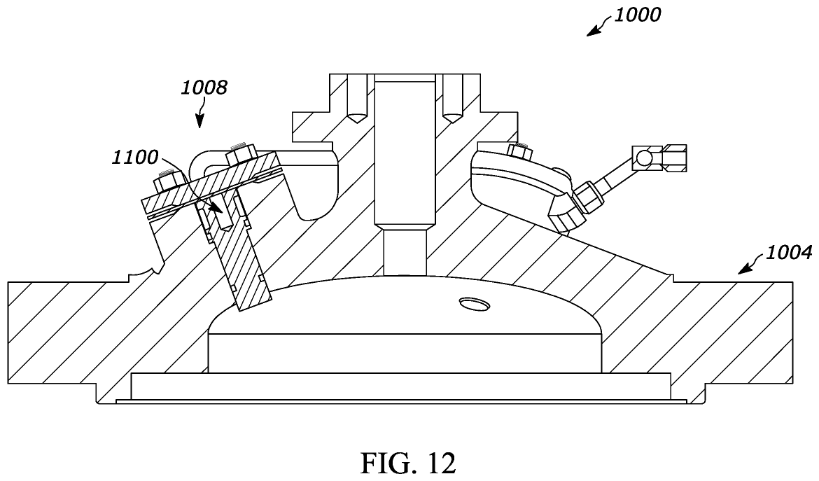

FIGS. 10-12 illustrate another example of an assembly 1000 constructed in accordance with the teachings of the present disclosure. Thus, the assembly 1000 is likewise configured to service an interior of a fluid control valve while the fluid control valve is operational. The assembly 1000 is structurally and functionally similar to the assembly 100 but is different in one way. Like the assembly 100, the assembly 1000 includes a bonnet 1004, three nozzle assemblies 1008 coupled to one another and to the bonnet 1004, and three spray plugs 1100 (only one of which is visible) that can be used to replace the three spray nozzles of the nozzle assemblies 1008 and maintain the pressure within the fluid control valve, when desired. While the bonnet 1004 is identical to the bonnet 104, the main body 1016 of each of the three nozzle assemblies 1008 is integrally formed with the bonnet 1004 (instead of being separately formed and then welded to the bonnet 1004, as is the case with the main body 116 of each of the three nozzle assemblies 108 described above). However, it will be appreciated from FIGS. 10-12 that each of the nozzle assemblies 1008 is otherwise structurally and functionally identical to the nozzle assemblies 108 described above. Thus, further details about the nozzle assemblies 1008 will be omitted for brevity.

Finally, it will be appreciated that any of the nozzle assemblies described herein can be used in connection with a different bonnet than the bonnets described herein. In a first alternative example, the nozzle assemblies 108 can be used in connection with a different bonnet than the bonnet 104. In a second alternative example, one or more of the nozzle assemblies 108 can be installed within a bonnet via an underside of the bonnet and then coupled to a source of servicing fluid via one or more holes formed in the bonnet. In this second alternative example, the one or more nozzle assemblies 108 would not necessarily be removable or accessible from the outside of the bonnet but would still be operable to perform the same cleaning functionality as the other nozzle assemblies described herein. Moreover, in a third alternative example, the second alternative example can be modified so that the one or more nozzle assemblies 108 are secured within the bonnet via one or more components other than the respective main bodies 116 and the respective flanges 124, e.g., via one or more flanges integrally formed with the bonnet, in which case the one or more nozzle assemblies 108 need not necessarily include the respective main bodies 116 and/or the respective flanges 124.

Preferred embodiments of this invention are described herein, including the best mode or modes known to the inventors for carrying out the invention. Although numerous examples are shown and described herein, those of skill in the art will readily understand that details of the various embodiments need not be mutually exclusive. Instead, those of skill in the art upon reading the teachings herein should be able to combine one or more features of one embodiment with one or more features of the remaining embodiments. Further, it also should be understood that the illustrated embodiments are exemplary only and should not be taken as limiting the scope of the invention. All methods described herein can be performed in any suitable order unless otherwise indicated herein or otherwise clearly contradicted by context. The use of any and all examples, or exemplary language (e.g., “such as”) provided herein, is intended merely to better illuminate the aspects of the exemplary embodiment or embodiments of the invention, and do not pose a limitation on the scope of the invention. No language in the specification should be construed as indicating any non-claimed element as essential to the practice of the invention.

1. A nozzle assembly for servicing an interior of a fluid control valve while the fluid control valve is operational, the nozzle assembly configured to be coupled to a top side of a bonnet of the fluid control valve, the nozzle assembly comprising:
a main body adapted to engage the top side of the bonnet when the nozzle assembly is coupled to the top side of the bonnet, the main body including a central bore;
a spray nozzle removably coupleable to the main body, the spray nozzle comprising:
a nozzle body removably disposed in the central bore of the main body when the spray nozzle is coupled to the main body;
a flow passage extending through a portion of the nozzle body, the flow passage adapted to be coupled to a source of servicing fluid for the fluid control valve; and
a nozzle tip coupled to an end of the nozzle body and in fluid communication with the flow passage, such that when the main body engages the top side of the bonnet and the nozzle body is removably disposed in the central bore of the main body, the nozzle tip is positioned within an interior of the bonnet, thereby allowing the nozzle tip to distribute the servicing fluid from the source of servicing fluid into the interior of the bonnet; and
a flange removably coupleable to the main body to secure the spray nozzle within the main body.

2. The nozzle assembly of claim 1, further comprising a retaining element removably disposed between the flange and the spray nozzle, the retaining element configured to retain the nozzle body in the central bore of the main body.

3. The nozzle assembly of claim 1, further comprising a sealing element carried by the nozzle body, the sealing element configured to create a seal between the main body and the spray nozzle.

4. The nozzle assembly of claim 1, wherein the nozzle tip is removably coupled to the end of the nozzle body such that the nozzle tip is removable and replaceable with a second nozzle tip that provides different flow characteristics than the nozzle tip.

5. The nozzle assembly of claim 1, further comprising a spray plug that is removably disposable in the central bore of the main body when the spray nozzle is decoupled from the main body, the spray plug configured to seal the central bore of the main body.

6. The nozzle assembly of claim 1, wherein the nozzle body has a first portion disposed within the main body and a second portion disposed outside of the main body.

7. The nozzle assembly of claim 1, further comprising a controller communicatively connected to the spray nozzle, the controller configured to cause the nozzle tip to distribute the servicing fluid at a pre-determined time.

8. An assembly for servicing an interior of a fluid control valve while the fluid control valve is operational, the assembly comprising:
a bonnet adapted to be coupled to a valve body of the fluid control valve;
a nozzle assembly configured to be coupled to a top side of the bonnet, the nozzle assembly comprising:
a main body configured to engage the top side of the bonnet when the nozzle assembly is coupled to the top side of the bonnet, the main body including a central bore;
a spray nozzle removably coupleable to the main body, the spray nozzle including a nozzle body removably disposed in the central bore of the main body when the spray nozzle is coupled to the main body, a flow passage extending through a portion of the nozzle body and adapted to be coupled to a source of servicing fluid for the fluid control valve, and a nozzle tip coupled to an end of the nozzle body and in fluid communication with the flow passage, such that when the main body engages the top side of the bonnet and the nozzle body is removably disposed in the central bore of the main body, the nozzle tip is positioned within an interior of the bonnet and immediately adjacent an interior of the body of the fluid control valve, thereby allowing the nozzle tip to distribute the servicing fluid from the source of servicing fluid into the interior of the body of the fluid control valve; and
a flange removably coupleable to the main body to couple the spray nozzle to the main body.

9. The assembly of claim 8, wherein the nozzle assembly further comprises a retaining element removably disposed between the flange and the spray nozzle, the retaining element configured to retain the nozzle body in the central bore of the main body and to retain the nozzle tip within the interior of the bonnet.

10. The assembly of claim 8, further comprising a sealing element carried by the nozzle body, the sealing element configured to create a seal between the main body and the spray nozzle.

11. The assembly of claim 8, wherein the nozzle tip is removably coupled to the end of the nozzle body such that the nozzle tip is removable and replaceable with a second nozzle tip that provides different flow characteristics than the nozzle tip.

12. The assembly of claim 8, further comprising a spray plug that is removably disposable in the central bore of the main body when the spray nozzle is decoupled from the main body, wherein when the spray plug is removably disposed in the central bore of the main body, the flange is removably coupleable to the main body to securely retain the spray plug in the central bore of the main body, such that the spray plug is configured to seal the central bore of the main body.

13. The assembly of claim 8, wherein the nozzle body has a first portion disposed within the main body and a second portion disposed outside of the main body.

14. The assembly of claim 8, wherein the main body is integrally formed with the bonnet.

15. The assembly of claim 8, further comprising a trim assembly adapted to be disposed in the body of the fluid control valve, wherein when the main body engages the top side of the bonnet and the nozzle body is removably disposed in the central bore of the main body, the nozzle tip is positioned immediately adjacent a portion of the trim assembly, such that the nozzle tip distributes the servicing fluid from the source of servicing fluid onto the trim assembly.

16. The assembly of claim 8, wherein the bonnet comprises a central bore adapted to receive a stem for the fluid control valve, wherein the central bore of the bonnet extends along a first axis and wherein the central bore of the main body extends along a second axis that is angled relative to the first axis.

17. The assembly of claim 8, further comprising a gasket disposed between the main body and the flange when the flange is coupled to the main body.

18. The assembly of claim 8, further comprising a controller communicatively connected to the spray nozzle, the controller configured to cause the nozzle tip to distribute the servicing fluid at a pre-determined time.

19. A method of servicing an interior of a fluid control valve while the fluid control valve is operational, the fluid control valve comprising a body and a bonnet coupled to the body, the method comprising:
obtaining a spray nozzle comprising a nozzle body, a flow passage extending through a portion of the nozzle body, and a nozzle tip coupled to an end of the nozzle body and in fluid communication with the flow passage;
coupling the spray nozzle to a main body that engages a top side of the bonnet, such that the nozzle body is removably disposed in a central bore of the main body and the nozzle tip is positioned within an interior of the bonnet and immediately adjacent an interior of the valve body of the fluid control valve;
securely retaining the nozzle body in the central bore of the main body by coupling a flange to the main body;
fluidly coupling the flow passage of the spray nozzle to a source of servicing fluid for the fluid control valve; and
distributing, via the nozzle tip, the servicing fluid from the source of servicing fluid into the interior of the bonnet and the interior of the body of the fluid control valve.

20. The method of claim 19, further comprising:
removing the flange from the main body;
decoupling the spray nozzle from the main body by removing the nozzle body from the central bore of the main body;
obtaining a spray plug;
removably disposing the spray plug in the central bore of the main body; and
securely retaining the spray plug in the central bore of the main body by re- coupling the flange to the main body.
